(19) United States
(12) Patent Application Publication
(10) Pub. No.: US 2024/0149507 A1
(43) Pub. Date: May 9, 2024

(54) SYSTEM AND METHOD OF MOLDING A HOLLOW ARTICLE

(71) Applicant: MARKDOM INTERNATIONAL INC., Toronto (CA)

(72) Inventor: Changize SADR, Toronto (CA)

(21) Appl. No.: 18/413,931

(22) Filed: Jan. 16, 2024

Related U.S. Application Data
(63) Continuation of application No. PCT/CA2022/051118, filed on Jul. 19, 2022.
(60) Provisional application No. 63/203,381, filed on Jul. 20, 2021.

(51) Int. Cl. B29C 45/14; B29C 45/16; B29D 23/00; B29C 45/26; B29K 23/00; B29K 77/00; B29K 105/00

(52) U.S. Cl. CPC B29C 45/14467; B29C 45/16; B29D 23/00; B29C 2045/14524; B29C 2045/2683; B29K 2023/06; B29K 2023/12; B29K 2077/00; B29K 2105/0094; B29K 2995/0017

(57) ABSTRACT

A method of forming a hollow article includes injecting a first molding material into a first mold cavity at a first injection pressure to form a first molded shell and injecting a second molding material into a second mold cavity at a second injection pressure to form a second molded shell. The first molded shell has a first peripheral edge, and the second molded shell has a second peripheral edge. The method includes positioning the first shell and second shell into facing relation with the first and second peripheral edges in a third cavity, and injecting a third molding material into the third cavity at a third injection pressure to bond together the first and second shells along the first and second peripheral edges to form the hollow article. The third injection pressure is less than the first injection pressure by at least about 3.5 bar.

### CROSS-REFERENCE TO RELATED APPLICATIONS

This application is a continuation of PCT International Application no. PCT/CA2022/051118, filed on Jul. 19, 2022, which claims the benefit of U.S. Provisional Patent Application No. 63/203,381, filed on Jul. 20, 2021, each of which is hereby incorporated herein by reference in its entirety.

### FIELD

The specification relates generally to injection molding, and more specifically, to molding a hollow article.

### BACKGROUND

U.S. Pat. No. 10,786,934 (Denso Corp.) purports to disclose a method including a first molding process and a second molding process performed repeatedly. The first molding process includes injecting resin into a first pair of molds, in which a first pair of divided pieces is formed and which is fitted together without an inner mold, to couple the first pair of divided pieces to form a first hollow article at an injection station. The second molding process includes (i) injecting resin into a third pair of molds, which is fitted together with one inner mold interposed therebetween, to mold a third pair of divided pieces at the injection station, (ii) taking out the first hollow article from the first pair of molds at a removing station, and (iii) removing another inner mold from a second pair of molds while leaving a second pair of divided pieces between the second pair of molds at the setup station.

U.S. Pat. No. 9,636,888 (Ford Global Technologies LLC) purports to disclose joint designs, tooling, and molding methods for a hollow object, such as an automobile bolster. This publication purports to disclose that the methods and structures provide a process and system that facilitates mold alignment, part alignment, material strength, design adaptability, efficient processing, reduced labor, increased production rates, reduced energy consumption per part, aesthetically pleasing surfaces, and reduces or eliminates the need for welding.

U.S. Pat. No. 7,147,816 (Japan Steel Works Ltd.) purports to disclose a pair of primary semi-hollow bodies formed by primary injection molding that are united together by the molten resin injected for secondary injection molding to fill a joining space defined about the butt ends of the primary semi-hollow bodies having their open ends butted against each other. The molten resin for secondary molding fills the space between the butt ends, or the notch portion, too. Alternatively, the molten resin is compressed after filling the joining space and the space between the butt ends.

### SUMMARY

The following summary is intended to introduce the reader to various aspects of the applicant's teaching, but not to define any invention.

According to some aspects, a method of forming a hollow article includes injecting a first molding material into a first mold cavity at a first injection pressure to form a first molded shell and injecting a second molding material into a second mold cavity at a second injection pressure to form a second molded shell. The first molded shell has an outwardly bulging first body at least partially bounded by a first peripheral edge, and the second molded shell has an outwardly bulging second body at least partially bounded by a second peripheral edge. The method also includes positioning the first shell and second shell into facing relation, with outer surfaces of the outwardly bulging first and second bodies directed away from one another and an empty chamber formed between them, and with the first and second peripheral edges proximate one another and disposed within a third mold cavity. The method further includes injecting a third molding material into the third cavity at a third injection pressure to join together the first and second shells along the first and second peripheral edges to form the hollow article. The third injection pressure is less than the first injection pressure by at least about 3.5 bar, wherein inward deflection of the first and second shells as a result of injecting the third molding material is avoided.

In some examples, the second molding material is injected into the second cavity at a second injection pressure, the second injection pressure being one of (i) generally equal to the first injection pressure, and (ii) greater than the first injection pressure.

In some examples, the third molding material has a higher melt flow index than the first and second molding materials.

In some examples, the third molding material comprises a low molecular weight plastic resin.

In some examples, the third molding material comprises a gas that is mixed into the third molding material prior to injecting the third molding material into the third mold cavity.

In some examples, the gas, which may preferably comprise nitrogen, carbon dioxide, or ambient air, is introduced by a blowing agent comprising at least one of (i) a physical blowing agent (such as HCFC, hydrocarbons, liquid carbon dioxide); (ii) a chemical blowing agent (such as hydrazine, sodium bicarbonate); and (iii) the gas itself mechanically injected directly into the third molding material.

In some examples, the third injection pressure is less than about 175 bar.

In some examples, the first injection pressure is at least about 230 bar, and the third injection pressure is less than about 160 bar.

In some examples, the first injection pressure is in a range of about 240 bar to about 300 bar, and the third injection pressure is in a range of about 125 bar to about 150 bar.

In some examples, the third molding material is weld-compatible with the first and second molding materials.

In some examples, the first molding material comprises one of polypropylene and polyethylene, and the second molding material comprises a high heat-resistant material, the high heat-resistant material preferably having a continuous service temperature of at least 130 degrees Celsius, and in some examples, at least 150 degrees Celsius.

In some examples, the third molding material comprises a functionalized polyolefin.

In some examples, the third molding material comprises maleic anhydride grafted polyethylene.

In some examples, the first molding material comprises a first resin, the second molding material comprises a second resin, and the third molding material comprises a third resin.

In some examples, the first and second resins are polyolefin.

In some examples, the first and second resins are the same.

In some examples, the third resin is the same as the first and second resins.

In some examples, the first, second, and third resins are polyolefin.

In some examples, the first, second, and third resins are one of the group consisting of (i) polyethylene, and (ii) polypropylene.

In some examples, at least one of the first and second resins is polyamide.

In some examples, the first peripheral edge comprises a first flange having a first flange inner end proximate the first body and a first flange outer end spaced outwardly of the first flange inner end, and wherein the second peripheral edge comprises a second flange having a second flange inner end proximate the second body and a second flange outer end spaced outwardly of the second flange inner end, and wherein step (c) includes bringing the first flange inner end into abutment with the second flange inner end.

In some examples, step (c) includes closing opposing mold halves against the first and second flange inner ends, the third cavity extending outwardly from the first and second flange inner ends and about the first and second flange outer ends when the opposing mold halves are closed against the first and second flange inner ends.

In some examples, steps (a) and (b) are performed simultaneously.

In some examples, a first injection unit is used to perform steps (a) and (b).

In some examples, step (d) is performed at the same time that steps (a) and (b) are repeated in a subsequent cycle to produce another pair of first and second molded shells.

In some examples, step (d) is performed by the same first injection unit used to perform steps (a) and (b).

In some examples, a second injection unit is used to perform step (d).

According to some aspects, a hollow article is formed by a method as outlined above.

In some examples, the hollow article comprises an automotive inlet duct.

According to some aspects, a hollow article includes a first molded shell comprising a first molding material and formed by injecting the first molding material into a first cavity, and a second molded shell comprising a second molding material and formed by injecting the second molding material into a second mold cavity. The first molded shell has an outwardly bulging first body at least partially bounded by a first peripheral edge, the first peripheral edge comprising a first flange having a first flange inner end proximate the first body and a first flange outer end spaced outwardly of the first flange inner end. The second molded shell having an outwardly bulging second body at least partially bounded by a second peripheral edge, the second peripheral edge comprising a second flange having a second flange inner end proximate the second body and a second flange outer end spaced outwardly of the second flange inner end. The second molded shell is oriented in facing relation to the first outer shell, with outer surfaces of the outwardly bulging first and second bodies directed away from one another and front surfaces of the first and second peripheral edges abutting one another. The hollow article also includes a bead including a third molding material and formed by injecting the third molding material into a third mold cavity. The bead extends along the first and second outer edges of the first and second peripheral edges, and the bead joins together the first and second molded shells to form the hollow article.

In some examples, the bead includes a first bead portion overlying and joined to a first back surface portion of the first flange opposite the first front face, and a second bead portion overlying and joined to a second back surface portion of the second flange opposite the second front face.

In some examples, the first bead portion is spaced apart from the first body by a first gap, and the second bead portion is spaced apart from the second body by a second gap, the first and second gaps accommodating portions of respective first and second mold walls of the third mold cavity when forming the bead.

### BRIEF DESCRIPTION OF THE DRAWINGS

The drawings included herewith are for illustrating various examples of articles, methods, and apparatuses of the present specification and are not intended to limit the scope of what is taught in any way. In the drawings:

FIG. 1 is a perspective view of a first example hollow article;

FIG. 1A is an expanded view of a portion of FIG. 1;

FIG. 2 is a schematic cross sectional view of a portion of the example hollow article of FIG. 1 showing a bead joining together the first and second molded shells;

FIG. 3 is a schematic cross sectional view of an alternative bead joining together the first and second molded shells of the hollow article of FIG. 1;

FIG. 3A is a schematic cross sectional view of a portion of another example hollow article showing a bead joining together first and second molded shells of the article;

FIG. 4 is a flow chart of a method of forming a second example hollow article;

FIG. 5 is a schematic elevation view of a first example injection molding machine with a mold in a closed configuration as a first molded shell and a second molded shell of a third hollow article are formed;

FIG. 6 is a schematic elevation view of the machine of FIG. 5 with a mold in an open configuration as the first molded shell and the second molded shell are repositioned;

FIG. 7 is a schematic elevation view of the machine of FIG. 5 with the mold in the closed configuration after the first molded shell and the second molded shell have been repositioned;

FIG. 8 is a schematic elevation view of the machine of FIG. 5 with the mold in the closed configuration as the first molded shell and the second molded shell are bonded together to form the third example hollow article;

FIG. 9 is a schematic elevation view of the machine of FIG. 5 with the mold in the open configuration as the third example hollow article is removed;

FIG. 10 is a perspective view of the third example hollow article;

FIG. 11 is a schematic elevation view of a second example injection molding machine with a mold in a closed configuration as a first molded shell and a second molded shell of a fourth hollow article are formed;

FIG. 12 is a schematic elevation view of the machine of FIG. 11 with the mold in an open configuration as the first molded shell and the second molded shell are repositioned;

FIG. 13 is a schematic elevation view of the machine of FIG. 11 with the mold in the closed configuration after the first molded shell and the second molded shell have been repositioned;

FIG. 14 is a schematic elevation view of the machine of FIG. 11 with the mold in the closed configuration as the first molded shell and the second molded shell are bonded together to form the fourth example hollow article;

FIG. 15 is a schematic elevation view of the machine of FIG. 11 with the mold in the open configuration as the fourth example hollow article is removed;

FIG. 16 is a perspective view of the fourth example hollow article; and

FIG. 17 is a schematic elevation view of another injection molding machine with a mold in a closed configuration as a first molded shell and a second molded shell of another hollow article are formed.

### DETAILED DESCRIPTION

Various apparatuses or processes will be described below to provide an example of an embodiment of each claimed invention. No embodiment described below limits any claimed invention and any claimed invention may cover processes or apparatuses that differ from those described below. The claimed inventions are not limited to apparatuses or processes having all of the features of any one apparatus or process described below or to features common to multiple or all of the apparatuses described below. It is possible that an apparatus or process described below is not an embodiment of any claimed invention. Any invention disclosed in an apparatus or process described below that is not claimed in this document may be the subject matter of another protective instrument, for example, a continuing patent application, and the applicants, inventors or owners do not intend to abandon, disclaim, or dedicate to the public any such invention by its disclosure in this document.

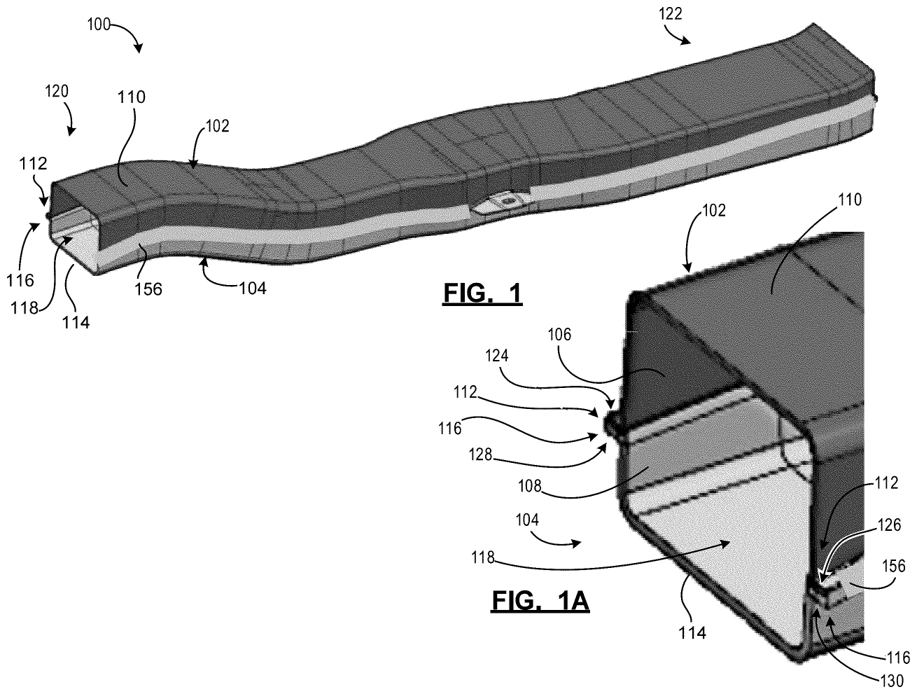

Referring to FIGS. 1 and 1A, an example hollow article 100 includes a first molded shell 102 bonded to a second molded shell 104. The first molded shell 102 has an outwardly bulging first body 106 with a first outer surface 110 and a first peripheral edge 112. The second molded shell 104 has an outwardly bulging second body 108 with a second outer surface 114 and a second peripheral edge 116. An empty chamber 118 is formed between the first molded shell 102 and the second molded shell 104.

In some examples, the hollow article 100 comprises a part for an automobile. For example, the illustrated example hollow article 100 comprises an automotive intake duct. The exemplary empty chamber 118 is an elongated chamber that is open at a first end 120 of the hollow article 100 and open at a second end 122 of the hollow article 100 opposite the first end 120. However, it is to be understood that in some examples a hollow article is configured for another use. In some examples, a hollow article includes an empty chamber that is not an elongated chamber, is not open at a first end of the hollow article, and/or is not open at a second end of the hollow article. For example, a hollow article may include a generally cuboid or spherical empty chamber that is entirely enclosed.

In the example illustrated, the first body 106 is at least partially bounded by the first peripheral edge 112, and the second body 108 is at least partially bounded by the second peripheral edge 116. The exemplary first and second peripheral edges 112, 116 each include a plurally of segments. The first peripheral edge 112 includes a first peripheral edge first segment 124 and a first peripheral edge second segment 126. The second peripheral edge 116 includes a second peripheral edge first segment 128 and a second peripheral edge second segment 130.

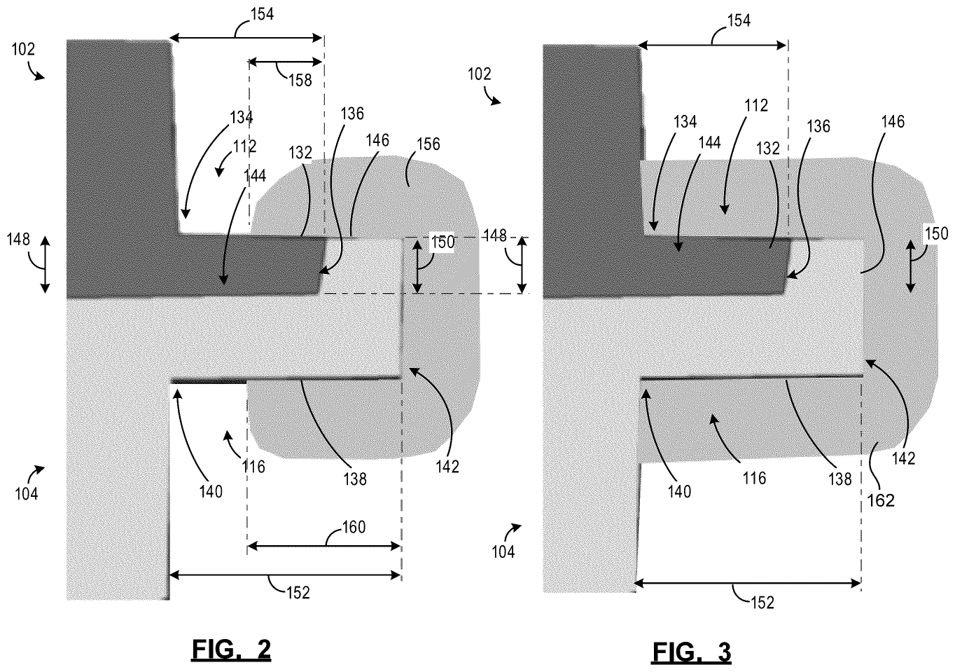

Referring to FIG. 2, the exemplary first peripheral edge 112 comprises a first flange 132 (i.e., a flange segment on each segment of the first peripheral edge 112). The first flange 132 has a first flange inner end 134 proximate the first body 106 and a first flange outer end 136 spaced outwardly of the first flange inner end 134. The exemplary second peripheral edge 116 comprises a second flange 138 (i.e., a flange segment on each segment of the second peripheral edge 116). The second flange 138 has a second flange inner end 140 proximate the second body 108 and a second flange outer end 142 spaced outwardly of the second flange inner end 140.

The exemplary second flange 138 includes a recess 144 disposed inwardly of a raised leg 146 at the second flange outer end 142. The raised leg 146 extends out from the second flange 138 opposite the second body 108. The first flange 132 and the second flange 138 are configured such that the first flange 132 may be arranged within the recess 144, with the first flange outer end 136 positioned behind the raised leg 146.

The exemplary first flange 132 has a thickness 148 about equal to a height 150 of the raised leg 146. The second flange 138 has a second length 152 that is greater than a first length 154 of the first flange 132.

In the example illustrated, the first molded shell 102 and the second molded shell 104 are arranged in facing relation with the first outer surface 110 and the second outer surface 114 directed away from one another and the empty chamber 118 formed between them. In the example illustrated, the first peripheral edge 112 and the second peripheral edge 116 are proximate one another, with the first flange inner end 134 abutting the second flange inner end 140. The first flange outer end 136 abuts the second flange outer end 142.

The first molded shell 102 and the second molded shell 104 are bonded together along the first peripheral edge 112 and the second peripheral edge 116. Each segment of the first and second peripheral edges 112, 116 is bonded to a segment of the other of the first and second peripheral edges 112, 116.

The first peripheral edge 112 and the second peripheral edge 116 are bonded together in the illustrated example by an over molded bead 156 (i.e., each abutting pair of segments of the edges 112, 116 is bonded together by a segment of bead 156). With the first flange outer end 136 abutting the second flange outer end 142 the bead overlays the first flange outer end 136 and the second flange outer end 142.

The bead 156 covers the first flange outer end 136 and the second flange outer end 142, and extends along the first flange 132 for a first portion 158 of the first length 154 and along the second flange for a second portion 160 of the second length 152.

Referring to FIG. 3, illustrated is example of an alternate bead 162 between the first peripheral edge 112 and the second peripheral edge 116. The alternate bead 162 overlays the first flange outer end 136 and the second flange outer end 142, and extends along the first flange 132 along the entire first length 154 and extends along the second flange 138 along the entire second length 152.

In the example illustrated, the first flange 132, the second flange 138, the recess 144, and/or the raised leg 146 may contribute to a stronger joint between the first molded shell 102 and the second molded shell 104. However, in some examples the first flange 132, the second flange 138, the recess 144, and/or the raised leg 146 may have a different configuration, and still be securely bonded by the bead 156 or the bead 162.

In other examples, the first and second peripheral edges 112, 116 may each include a recess rather than a flange, and the first and second peripheral edges 112, 116 may be brought together with the recesses abutting one another to form a gap between them, and a bond may be formed by filling the gap with an injection molding material adhered to each of the first and second peripheral edges 112, 116.

Referring to FIG. 3A, illustrated is an example of alternate shells 102′, 104′. Shells 102′, 104′ are similar in many respects to shells 102 and 104, and like features are indicated by like reference numbers followed by an apostrophe.

The exemplary first peripheral edge 112′ comprises a first flange 132′. The first flange 132′ has a first flange inner end 134′ and a first flange outer end 136′ spaced outwardly of the first flange inner end 134′. The exemplary second peripheral edge 116′ comprises a second flange 138′. The second flange 138′ has a second flange inner end 140′ and a second flange outer end 142′ spaced outwardly of the second flange inner end 140′.

The exemplary first flange 132′ includes a raised first leg 133′. The first leg 133′ extends at an angle (e.g. a right angle) from a main body of the first flange 132′ to form a hooked end of the flange 132′. The exemplary first leg 133′ protrudes forward of the front face 136′ of the flange 132′. The exemplary first leg 133′ extends out from the flange 132′ generally parallel to the first body 106′. The exemplary second flange 138′ includes a raised second leg 139′. The exemplary second leg 139′ protrudes forward of the second front face 142′ of the second flange 138′. The exemplary second leg 139′ extends from the flange generally parallel to the second body 108′. The second leg 139′ extends at an angle (e.g. a right angle) from a main body of the second flange 138′ to form a hooked end of the flange 138′. The hooked ends may be embedded in a joining bead (e.g., bead 156′), to help secure the flanges within the bead and securely join the shells together.

In the example illustrated, the first molded shell 102′ and the second molded shell 104′ are arranged in facing relation with the outer surfaces of the shells directed away from one another and an empty chamber formed between the shells. In the example illustrated, the first peripheral edge 112′ and the second peripheral edge 116′ are proximate one another, with the first flange inner end 134′ abutting the second flange inner end 140′. The first flange outer end 136′ abuts the second flange outer end 142′.

The first molded shell 102′ and the second molded shell 104′ are bonded together along the first peripheral edge 112′ and the second peripheral edge 116′. Each segment of the first and second peripheral edges 112′, 116′ is bonded to a segment of the other of the first and second peripheral edges 112′, 116′.

The first peripheral edge 112′ and the second peripheral edge 116′ are bonded together in the illustrated example by an over molded bead 156′. With the first flange outer end 136′ abutting the second flange outer end 142′ the bead overlays the first flange outer end 136′ and the second flange outer end 142′. The first and second legs 133′ and 139′ are embedded in the bead 156′. The bead 156′ covers the first flange outer end 136′ and the second flange outer end 142, and extends along the first flange 132′ for a first portion 158′ of the first length 154′ and along the second flange fora second portion 160′ of the second length 152′.

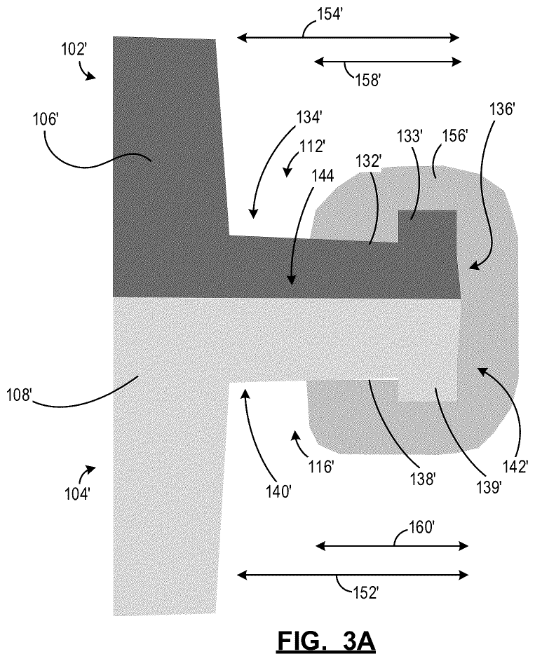

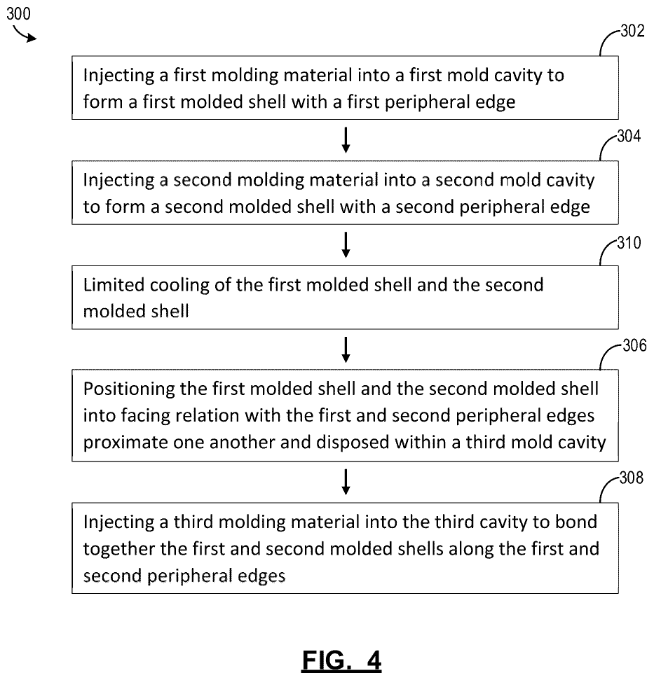

Referring to FIG. 4, a method 300 of forming a hollow article (e.g., the hollow article 100) includes, at step 302, injecting a first molding material into a first mold cavity to form a first molded shell. The method 300 also includes, at step 304 injecting a second molding material into a second mold cavity to form a second molded shell. The first molded shell produced at step 302 has an outwardly bulging or convex first body and a first peripheral edge (e.g., the first molded shell 102). The second molded shell produced at step 304 has an outwardly bulging or convex second body and a second peripheral edge (e.g., the second molded shell 104).

The first molding material of step 302 is injected at a first injection pressure. In some examples, the first injection pressure of step 302 is at least about 200 bar, 210 bar, 220 bar, 230 bar, or 240 bar. In some examples, the first injection pressure of step 302 is at least about 230 bar. In some examples, the first injection pressure of step 302 is in a range of about 240 bar to about 300 bar.

The second molding material of step 304 is injected at a second injection pressure. In some examples, the second injection pressure of step 304 is approximately equal to the first injection pressure of step 304. In some example, the second injection pressure of step 304 is greater than the first injection pressure of step 302.

The first molding material of step 302 comprises a first resin. The second molding material of step 304 comprises a second resin. In some examples, the first and second resins of steps 302 and 304 are substantially the same. In some examples, the first and second resins of steps 302 and 304 are or include polyolefin. In some examples, the first and second resins of steps 302 and 304 are or include one of the group consisting of (i) polyethylene, and (ii) polypropylene.

In some examples, the method 300 produces a hollow article configured for use in a high-heat environment. The high-heat environment may be an environment with a temperature above 40 degrees Celsius, 50 degrees Celsius, or 60 degrees Celsius. The high-heat environment may be an engine compartment of an automobile.

The first and second resins of steps 302 and 304 may be selected to remain solid in the high-heat environment. In some examples, the first and second resins of steps 302 and 304 are or include polyamide.

In some examples, steps 302 and 304 may occur at about the same time (i.e., simultaneously). Performing steps 302 and 304 simultaneously may reduce the cycle time of method 300. Performing steps 302 and 304 simultaneously may facilitate using a single injection unit for both steps.

It is contemplated that the first and second cavities may be joined to the same injection unit (e.g., to facilitate receiving the same injection molding material, at generally the same time, and/or at generally the same pressure) or may be to discrete injection units (e.g., to facilitate receiving different injection molding materials, at different times, and/or at different pressures).

The method 300 includes, at 306, positioning the first molded shell produced at 302 and the second molded shell produced at 304 into facing relation. The first molded shell and the second molded shell may be positioned at 306 in various ways. For example, the first molded shell and/or the second molded shell may be picked up (e.g., by a pick-and-place robot) from the cavity in which they were formed and moved to another cavity. In another example, the mold body forming the cavity in which the first molded shell and/or the second molded shell is formed may be moved (e.g., rotated) to position the corresponding shell.

Step 306 includes arranging the first and second shells such that a first outer surface (e.g., the first outer surface 110) of the first outwardly bulging or convex body and a second outer surface (e.g., the second outer surface 114) of the second outwardly bulging or convex body of the first and second shells produced at steps 302 and 304 are directed away from one another and an empty chamber (e.g., the empty chamber 118) is formed between the first outwardly bulging or convex body and the second outwardly bulging or convex body. Step 306 also includes positioning the first peripheral edge and the second peripheral edge proximate one another and disposed within a third mold cavity.

In some examples, the peripheral edges of the first and second shells produced at steps 302 and 304 each include a flange having a flange inner end proximate the body of the shell and a flange outer end spaced outwardly of the flange inner end (e.g., the flanges 132 and 138 of the hollow article 100), and step 306 includes bringing the flange inner ends into abutment.

The first and second shells produced at steps 302 and 304 may be bonded together at step 308 by an over molded bead (e.g., bead 156 or bead 162). In some examples, step 306 includes closing opposing mold halves against the first and second flange inner ends, the third cavity extending outwardly from the first and second flange inner ends and about the first and second flange outer ends when the opposing mold halves are closed against the first and second flange inner ends. In some examples, the third cavity used at step 308 extends along the entire length of the flanges of the first and second shells produced at steps 302 and 304 (e.g., to produce a bead such as bead 162). In some examples, the third cavity used at step 308 extends along only a portion of the entire length of the flange of the first shell produced at step 302 and/or a portion of the entire length of the flange of the second shell produced at step 304 (e.g., to produce a bead such as bead 156).

The method 300 includes, at step 308, injecting a third molding material into the third cavity (i.e., the cavity in which the first and second peripheral edges are disposed proximate one another) to bond together the first and second molded shells produced at steps 302 and 304 along the first and second peripheral edges to form the hollow article. For example, injecting the third molding material into the third cavity in which the first and second peripheral edges are disposed proximate one another may form a bead over the first and second peripheral edges (e.g., bead 156 or alternate bead 162) and/or a bond between the first and second peripheral edges. In some examples, the third molding material of step 308 is weld compatible with the first and second mold materials of steps 302 and 304.

The present teaching seeks to avoid inward deflection of the first and/or second shells (e.g., shells 102, 104 and/or the shells produced at steps 302 and 304) that could otherwise occur as a result of injecting a material around and/or against the shells (e.g., injecting a third molding material at step 308). In some examples, this is accomplished by injecting the material (e.g., the third molding material at step 308) at a low pressure; and/or providing the material with a geometry that that reduces the chance for deflection (e.g., the shape of bead 156, bead 162, and/or bead 165); and/or holding portions of the shells in the mold in such a way that deflection is avoided.

In some examples, the third molding material is injected at step 308 into the third cavity at a third injection pressure. The third injection pressure of step 308 may be less than the first injection pressure of step 302. A reduced pressure may reduce the inward deflection of the first and second shells as a result of injecting the third molding material in step 308. In some examples, the third injection pressure of step 308 is less than 90 percent, less than 80 percent, less than 75 percent, less than 60 percent, or less than 50 percent of the first injection pressure of step 302. In some examples, the third injection pressure of step 308 is less than about 75 percent of the first injection pressure. A third injection pressure of less than about 75 percent of the first injection pressure may avoid inward deflection of the first and second shells as the result of injecting the third molding material at step 308.

The third injection pressure of step 308 may be less than 200 bar, 190 bar, 180 bar, 170 bar, 160 bar, or 150 bar. In some examples, the third injection pressure of step 308 is less than about 175 bar. In some examples, the third injection pressure of step 308 is less than about 160 bar. In some examples, the third injection pressure of step 308 is in a range of about 125 bar to about 150 bar.

In some examples, the third molding material of step 308 is a low molecular weight plastic resin. A low molecular weight plastic resin may facilitate injecting the third molding material of step 308 at a reduced pressure.

In some examples, the third molding material of step 308 includes a gas. Including a gas in the third molding material of step 308 may reduce the molecular weight of the plastic resin. The gas included in the third molding material of step 308 may be an inert and/or dry gas. In some examples, the gas included in the third molding material of step 308 includes at least one of nitrogen and carbon dioxide. In some examples, the gas included in the third molding material of step 308 is nitrogen.

In some examples, the gas included in the third molding material of step 308 is mixed into the third molding material prior to injecting the third molding material into the third mold cavity. For example, the gas may be mixed into the third molding material in the barrel or hopper of an injection unit, or added to a raw material provided to the injection unit. In some examples, the gas is introduced into the third molding material by adding a blowing agent to the third molding material. The blowing agent may be the gas itself, injected directly into the third molding material. The blowing agent may also be a physical blowing agent (such as HCFC, hydrocarbons, liquid carbon dioxide), and/or a chemical blowing agent (such as hydrazine, sodium bicarbonate). In some examples, the gas is introduced by mixing a chemical foaming resin into the third molding material, the chemical foaming resin releasing the gas while mixing with the third molding material.

The third molding material of step 308 comprises a third resin. In some examples, the third resin of step 308 is substantially the same as the first resin of step 302 and/or the second resin of step 304. In some examples, the third resin of step 308 is or includes polyolefin. In some examples, the third resin of step 308 is or includes one of the group consisting of (i) polyethylene, and (ii) polypropylene.

The third resin of step 308 may be selected to remain solid in a high-heat environment. In some examples, the third resin of step 308 is or includes polyamide.

In some examples, method 300 includes a cooling step 310. For example, step 310 may include limited cooling of the first molded shell of step 302 and/or limited cooling of the second molded shell of step 304. The cooling of step 310 may, in some expels, take place after steps 302 and 304 and before step 308, and provided limited cooling such that a portion of the first amount of thermal energy and/or a portion of the second amount of thermal energy from steps 302, 304 is retained in the first and second peripheral edges at the initiation of step 308. For example, step 310 may include circulating water or another cooling fluid around the first shell in the first cavity and/or around the second shell in the second cavity. In some examples, the method 300 may not include the cooling step 310 (e.g., method 300 may not include active cooling), or may include cooling that is not limited in the way described previously.

In some examples, the hollow article produced by method 300 is the hollow article 100 of FIG. 1.

Referring now to FIG. 5, illustrated is an example injection molding machine 1000 for use in forming a hollow article (e.g., the hollow article 100 of FIG. 1). The injection molding machine 1000 includes a moving platen 1002 and a stationary platen 1004. The moving platen 1002 and the stationary platen 1004 are each mounted to a base 1006 and are coupled together via tie bars 1008.

The moving platen 1002 and the stationary platen 1004 support respective mold halves 1010 and 1012 of a mold, which is shown in a closed configuration in FIG. 5. When closed, the first mold half 1010 and the second mold half 1012 define a first mold cavity 1020, a second mold cavity 1022, and a third mold cavity 1024. It is contemplated that in other examples the injection molding machine may include further cavities or mold half configurations.

The injection molding machine 1000 also includes injection units for injecting molding materials into the mold to form one or more molded article. For example, one or more injection units can be provided for injecting a first molding material into a first mold cavity at a first injection pressure to form a first molded shell, injecting a second molding material into a second mold cavity at a second injection pressure to form a second molded shell, the second molded shell, and injecting a third molding material into a third cavity at a third injection pressure to form beads along the first and second peripheral edges of the shells, to join the shells together and form the finished hollow article.

In the example illustrated, the machine 1000 includes a first injection unit 1030 for injecting the first molding material into the first mold cavity to form the first shell.

The first injection unit 1030, in the example illustrated, also injects molding material into the second cavity to form the second shell, the second shell being made from the same molding material as the first shell. In other examples, a separate second injection unit can be provided to inject a second molding material into the second cavity, the second molding material different than the first molding material. In the example illustrated, the machine 1000 includes another injection unit (called a third injection unit 1032) for injecting a third molding material into the third mold cavity for forming the bead along the peripheral edge of the molded article.

In the example illustrated, the first injection unit 1030 includes a first hopper 1036 to hold a first resin material 1038. The first hopper 1036 is mounted to a first barrel 1040 to feed the first resin material 1038 into the first barrel 1040. The first injection unit 1030 includes a first screw 1042 disposed in the first barrel 1040 to plasticize the first resin material 1038 within the first barrel 1040. The first injection unit 1030 also includes a first hydraulic system 1044 to inject the plasticized first resin material 1038 through a first nozzle 1046 and into the mold via a first sprue bushing.

The third injection unit 1032 includes a third hopper 1050 to hold a third resin material 1052. The third hopper 1050 is mounted to a third barrel 1054 to feed the third resin material 1052 into the third barrel 1054. The third injection unit 1032 includes a third screw 1056 disposed in the third barrel 1054 to plasticize the third resin material 1052 within the third barrel 1054. The third injection unit 1032 also includes a third hydraulic system 1058 to inject the third raw material 1052 through a third nozzle 1060 and into the mold via a third sprue bushing.

In the example illustrated, the second injection unit 1032 is configured to mix a gas with the third resin material. For example, the third injection unit 1032 may include an additive port in the barrel 1054 through which a gas may be introduced and mixed with the third resin.

The first injection unit 1030 and the third injection unit 1032 may be operated independently (i.e., the first molding material 1038 may be injected into the mold with and/or without the third material 1052 being injected into the mold).

In the example illustrated, the first injection unit 1030 is arranged to inject the first molding material 1038 into the first mold cavity 1020 and also into the second mold cavity 1022 (via a hot runner system 1048). The exemplary injection molding machine 1000 is configured to form the first molded shell 1102 and the second molded shell 1104 simultaneously, of the same molding material provided by the first injection unit (e.g., if the machine 1000 is used for method 300, both the first injection material of step 302 and the second injection material of step 304 are the first resin material 1038).

The third injection unit 1032 is arranged to inject the third molding material 1052 into the third mold cavity 1024 (i.e., through a third hot runner system 1062). The third molding material 1052 may be a different material than the first molding material 1038. The first molding material 1038 may be injected at a different time than the third molding material 1052. The first molding material 1038 may be injected at a different pressure than the third raw material 1052. For example, where the machine 1000 is used for method 300, the first injection material of step 302 and the second injection material of step 304 are the first molding material 1038 while the third injection material of step 308 is the third molding material 1052.

The first mold cavity 1020 is shaped to form the first molded shell 1102. The second mold cavity 1022 is shaped to form a second molded shell 1104. As exemplified in FIG. 5, the first raw material 1038 may be injected through the first sprue 1048 to fill the first and second cavities 1020, 1022 and form the first and second molded shells 1102, 1104.

Referring now to FIG. 10, the first molded shell 1102 includes an outwardly bulging or convex first body 1106 with a first outer surface 1110 and at least partially bounded by a first peripheral edge 1112 (e.g., similar to the first molded shell 102). The second molded shell 1104 includes an outwardly bulging or convex second body 1108 with a second outer surface 1114 and at least partially bounded by a second peripheral edge 1116 (e.g., similar to the second molded shell 104).

Referring now to FIG. 6, the moving platen 1002 and the stationary platen 1004 are shown in an open configuration in which the moving platen 1002 has been moved away from the stationary platen 1004 to open the mold. With the mold in an open configuration the first molded shell 1102 and the second molded shell 1104 may be repositioned.

In the example illustrated, and with reference to FIG. 6, after forming the first and second shells and opening the mold, the first molded shell 1102 and the second molded shell 1104 are picked out of the first and second cavities 1020, 1022 and positioned into facing relation in another set of recesses in the mold. For example, a pick-and-place robot may be used to pick up the first and second molded shells 1102, 1104 and move them to the second position recesses 1070.

In some examples, the injection molding machine 1000 may include one or more ejection pins or other ejection members to free the first and second molded shells 1102, 1104. In some examples, the first and second molded shells 1102, 1104 are cooled when in position in the first and second cavities 1020, 1022 prior to being moved. For example, fluid channels may be provided in the platens 1002, 1004 around the first and second cavities 1020, 1022 to hold a cooling fluid to be pumped past the cavities to carry away thermal energy.

In the second position recesses 1070 the outer surfaces 1110, 1114 of the outwardly bulging first and second bodies 1106, 1108 are directed away from one another, and the peripheral edges are aligned with, and directed towards, each other.

Referring now to FIG. 7, after repositioning the shells, the moving platen 1002 and the stationary platen 1004 are again brought into a closed configuration. Closing the mold with the first and second molded shells 1102, 1104 in the second position recesses 1070 brings the peripheral edges of the shells together, and forms an empty chamber between the body portions of the shells. The first and second peripheral edges 1112, 1116 are proximate one another and disposed within a third mold cavity 1024. The third mold cavity 1024 is shaped to form a bead 1156 (e.g., bead 156 or bead 162) to hold together the first and second molded shells 1102, 1104.

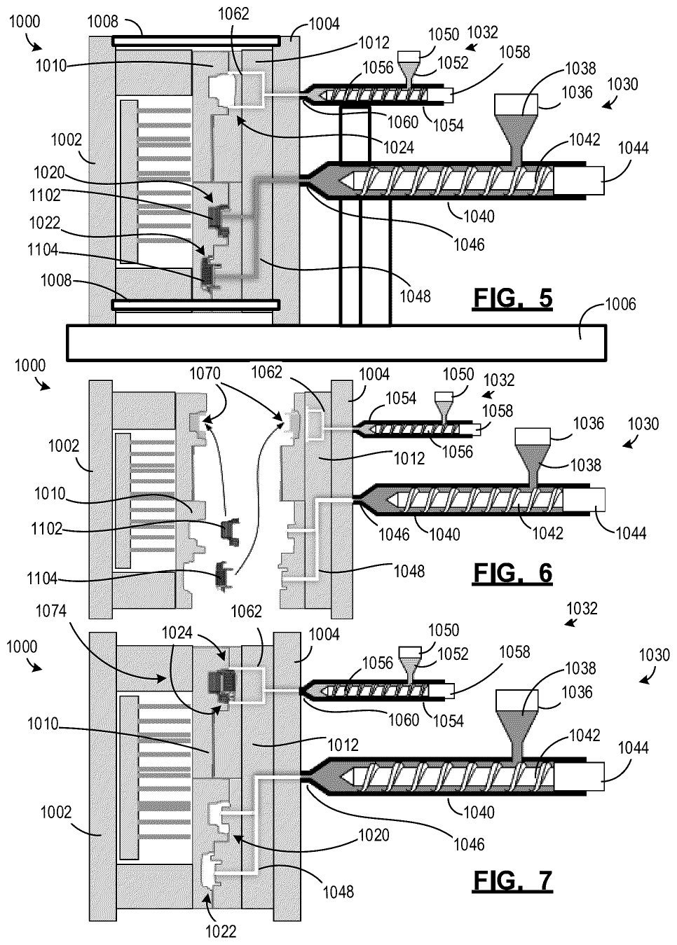

Referring to FIG. 8, once the mold is closed, the third molding material 1052 is injected into the third cavity 1024. Injecting the third molding material 1052 forms the beads and joins the first and second molded shells 1102, 1104 together along the first and second peripheral edges 1112, 1116 to form the hollow article 1100.

Injecting the third molding material to successfully form the bead around the peripheral edges of the mated shell halves can present some challenges. In particular, the pressure of the injected molding material (third molding material) can generate inwardly directed forces on the shells tending to deflect or buckle portions of the shells into the hollow chamber formed between the shell bodies. According to aspects of the present teaching, this risk can be mitigated by, in the example illustrated, using a third molding material that can be molded at significantly lower pressure than, for example, the injection pressure for injecting the first (and second) molding materials of the first and second shells.

In the example illustrated, the third molding material is a low viscosity, high melt flow index material, comprising a third resin mixed with nitrogen. This third molding material can be injected at low pressures, which can advantageously reduce inward forces acting on the first and second shells during injection of the third molding material to form the bead.

In some examples, the first molding material 1038 is also injected through the first hot runner system 1048 to form a second set 1072 (or second shell pair 1072) of first and second molded shells 1102, 1104 while a first set 1074 (or first shell pair 1074) of first and second molded shells 1102, 1104 is disposed in the second position recesses 1070 (i.e., with the first and second peripheral edges 1112, 1116 in the third cavity 1024). Injecting the first molding material 1038 to form the second set 1072 while the first set 1074 is in the second position recesses 1074 can improve operating efficiency and production rates by forming a first finished article (injecting the bead around shells produced in a previous injection cycle) while concurrently forming a second set of first and second shells to be used in a subsequent injection cycle for forming a second finished article.

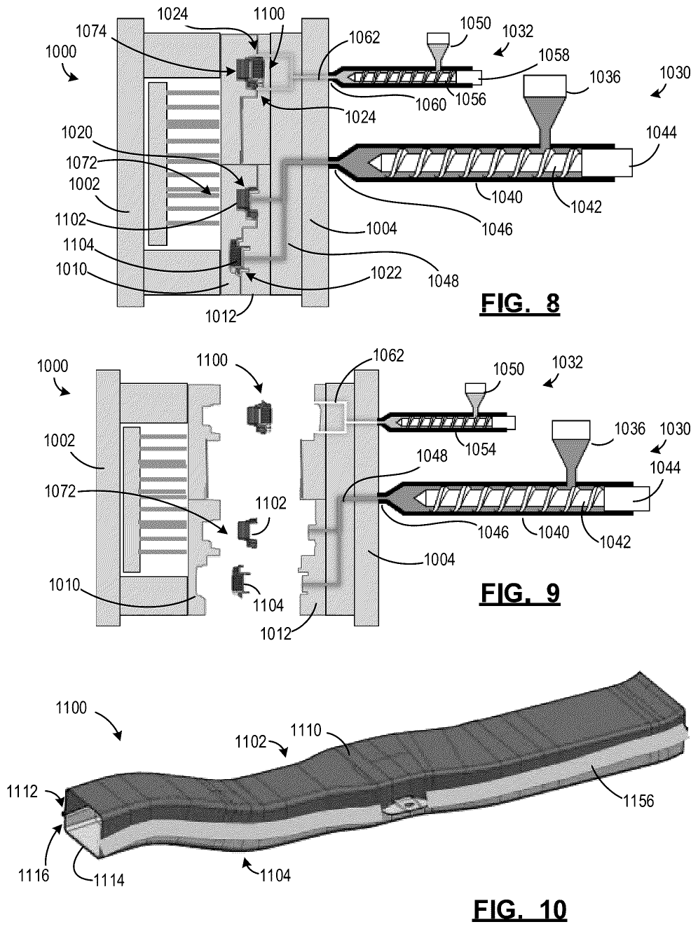

Referring now to FIG. 9, after forming the bead, the moving platen 1002 and the stationary platen 1004 may be opened again. Opening the platens 1002, 1004 allows the hollow article 1100 to be removed. In some examples, where the second set 1072 of shells 1102, 1104 has been formed while the first set 1074 was in the second position recesses 1070, opening the platens 1002, 1004 may also allow the second set 1072 of shells 1102, 1104 to be repositioned in the second position recesses 1070.

Referring now to FIG. 10, the hollow article 1100 produced by the injection molding machine 1000 may be similar in some respects to the hollow article 100 of FIG. 1, and like features are identified with like reference characters, incremented by 1000.

Referring now to FIG. 11, illustrated is another example injection molding machine 2000. The injection molding machine 2000 has similarities to the injection molding machine 1000, and like features are identified with like reference characters, incremented by 1000.

The injection molding machine 2000 includes a moving platen 2002 and a stationary platen 2004 for supporting a first mold half 2010 mounted to the moving platen 2002 and a second mold half 2012 mounted to the stationary platen 2004. With the mold in the closed position (FIG. 11), the first mold half 2010 and the second mold half 2012 define a first mold cavity 2020, a second mold cavity 2022, a third mold cavity 2024, and a fourth mold cavity 2025.

The injection molding machine 2000 also includes at least one injection unit to inject first, second, third, and fourth molding materials into the first, second, third, and fourth mold cavities. In the example illustrated, the machine 2000 includes a first injection unit 2030 and at least a third injection unit 2032.

The first injection unit 2030 is arranged to inject a first molding material 2038 through the stationary platen 2004 into the first mold cavity 2020. In the example illustrated, the first injection unit also injects second molding material into the second mold cavity 2022 (i.e., through the first hot runner system 2048). The exemplary injection molding machine 2000 is configured to form the first molded shell 2102 and the second molded shell 2104 of the same molding material (e.g., when using the machine 2000 for method 300, both the first injection material of step 302 and the second injection material of step 304 are the same molding material 2038).

The third injection unit 2032 is arranged to inject the third molding material 2052 through the stationary platen 2004 into the third mold cavity 2024 (i.e., through the third hot runner system 2062). The third molding material 2052 may be a different material than the first molding material 2038. The first molding material 2038 may be injected at a different time than the third molding material 2052. The first molding material 2038 may be injected at a pressure (a first injection pressure) that is different than a third injection pressure at which the third molding material 2052 is injected.

The first mold cavity 2020 is shaped to form a first molded shell 2102. The second mold cavity 2022 is shaped to form a second molded shell 2104. As exemplified in FIG. 5, the first molding material 2038 may be injected through the first hot runner system 2048 to fill the first and second cavities 2020, 2022 and form the first and second molded shells 2102, 2104.

Referring now to FIG. 16, the first molded shell 2102 includes an outwardly bulging first body 2106 with a first outer surface 2110 and at least partially bounded by a first peripheral edge 2112 (e.g., similar to the first molded shell 102). The second molded shell 2104 includes an outwardly bulging second body 2108 with a second outer surface 2114 and at least partially bounded by a second peripheral edge 2116 (e.g., the second molded shell 104).

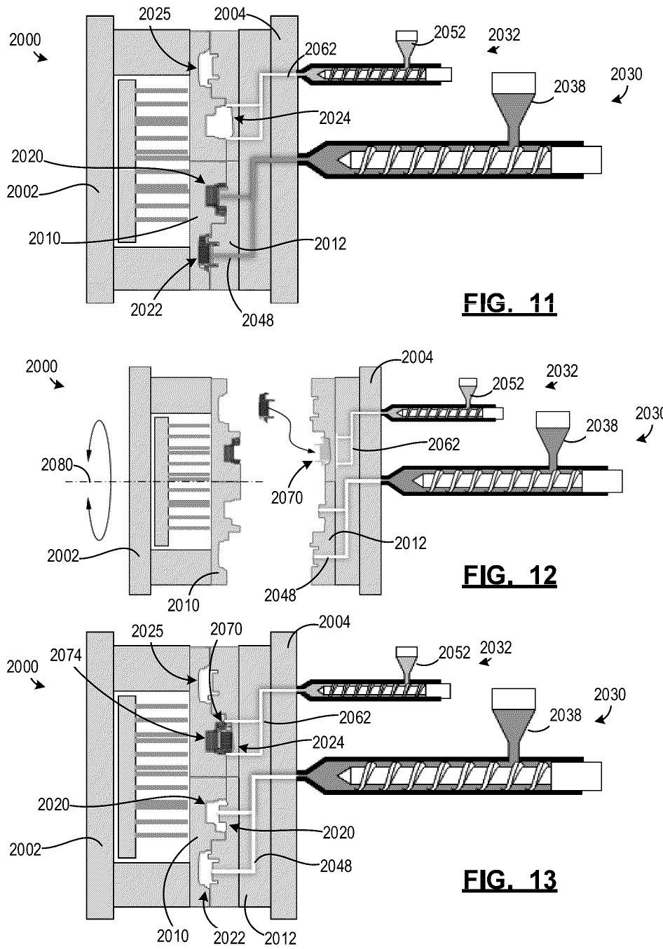

Referring now to FIG. 12, the moving platen 2002 and the stationary platen 2004 are shown in an open configuration in which the moving platen 2002 has been moved away from the stationary platen 2004 to open the mold. With the mold in an open configuration the first molded shell 2102 and the second molded shell 2104 may be repositioned. In the example illustrated, the moving platen 2002 includes a rotary plate to which the first mold half 2010 is mounted. Repositioning the shells includes rotating the first mold half 2010 about a central axis 2080 such that the recess of the mold half that was used to form the first molded shell 2102 is aligned with a second stage recess 2070 of the second mold half (i.e., a recess that is in communication with the third hot runner system 2062).

The first molded shell 2102 is carried by the first mold half as it is moved away from the second mold half and rotated about the central axis 2080. The second molded shell 2104 may also be carried by the first mold half as it is moved away from the first mold half and rotated about the central axis 2080. The second molded shell 2104 is picked up (e.g., by a pick and place robot) and placed in a second stage recess 2070 of the second mold half aligned with the recess of the first mold half carrying the first molded shell 2102 and positioned into facing relation. The outer surfaces 2110, 2114 of the outwardly bulging first and second bodies 2102, 2104 are directed away from one another.

Referring now to FIG. 13, after repositioning the shells, the mold (i.e. the moving platen 2002 and the stationary platen 2004) is again brought into a closed configuration. The first and second molded shells 2102, 2104 are brought together by the closing of the first and second mold halves, forming at least one empty chamber (a third mold cavity) between them. The aligned first and second peripheral edges 2112, 2116 are proximate one another and disposed within the third mold cavity 2024. The third mold cavity 2024 is shaped to form a bead 2156 (e.g., bead 156 or bead 162) to hold together the first and second molded shells 2102, 2104.

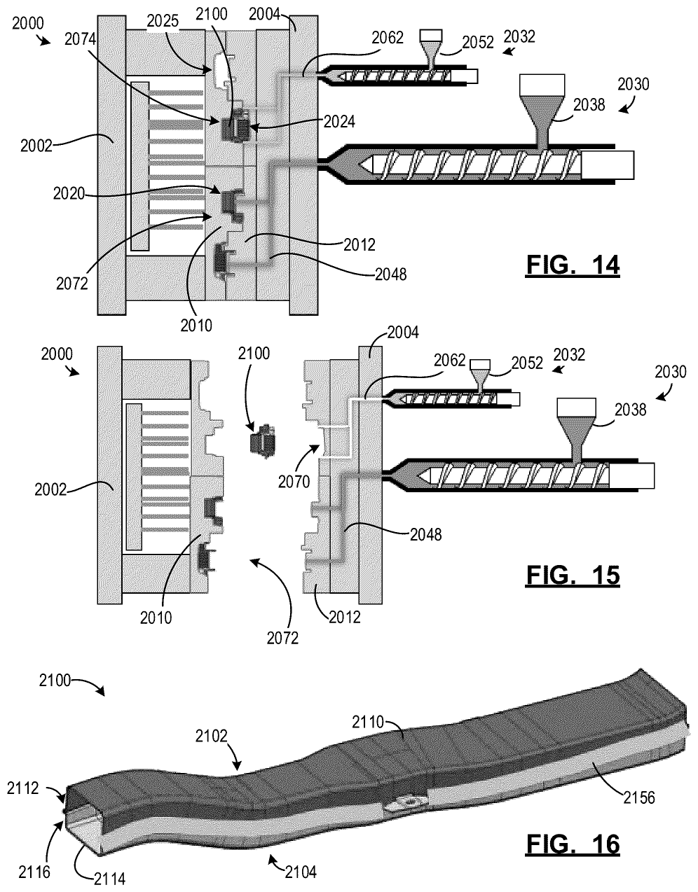

Referring to FIG. 14, the third molding material 2052 is injected through the third hot runner system 2062 to fill the third cavity 2024. Injecting the third molding material 2052 joins the first and second molded shells 2102, 2104 together along the first and second peripheral edges 2112, 2116 to form a hollow article 2100.

In some examples, the first raw material 2038 is also injected through the first hot runner system 2048 to form a second set 2072 of first and second molded shells 2102, 2104 while the peripheral edges 2112, 2116 of a first set 2074 of first and second molded shells 2102, 2104 are disposed in the third cavity 2024. Injecting the first raw material 2038 to form the second set 2072 while the first set 2074 is in facing relation may allow the injection molding machine to create a plurality of hollow articles 2100 concurrently.

Referring now to FIG. 15, after the bead has been formed, the moving platen 2002 and the stationary platen 2004 may be opened again. Opening the mold halves allows the hollow article 2100 to be removed. In some examples, where the second set 2072 of shells 2102, 2104 has been formed while peripheral edges 2112, 2116 of the first set 2074 were in the third cavity 2024, opening the platens 2002, 2004 may also allow the second set of shells 2102, 2104 to be repositioned into facing relation.

Referring now to FIG. 16, the hollow article 2100 produced by the injection molding machine 2000 may be similar in some respects to the hollow article 100 of FIG. 1, and like features are identified with like reference characters, incremented by 2000.

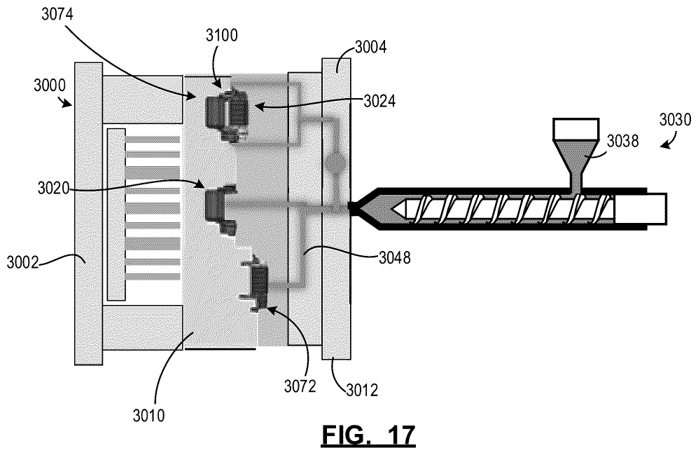

Referring now to FIG. 17, illustrated is another example injection molding machine 3000. The injection molding machine 3000 has similarities to the injection molding machine 1000, and like features are identified with like reference characters, incremented by 2000.

In the example illustrated, the machine 3000 has a single injection unit 3030 that fills each one of the first, second, and third mold cavities. In some examples, at least the third mold material is a low viscosity, high melt flow index material, which can facilitate forming the bead around the peripheral edges of the shells without distorting or deflecting the body portions of the shells into the hollow interior. In some examples, the first and second injection molding materials (injected into the first and second cavities for forming the first and second shells) are the same as the third molding material. The common molding material is, in some examples, a polyolefin mixed with a gas (nitrogen). The presence of small gas bubbles in the mold material can reduce the viscosity of the molding material which can facilitate injection at lower pressures, and can also reduce the weight and the amount of plastic required in the finished molded article.

In the example illustrated, the molding material from the injection unit 3030 flows into the first and second mold cavities via the first/second hot runner system 3048. The molding material from the injection unit 3030 flows to the third mold cavity via a third hot runner system 3062. In the example illustrated, a valve is positioned downstream of the third injection unit and upstream of the third mold cavities. The valve, in the example illustrated, acts as a pressure reducing valve to reduce the injection pressure of the third molding material injected into the third cavity. The valve also, in the example illustrated, serves to inject a gas (i.e. nitrogen or carbon dioxide) into the molten received from the injection unit 3030, to deliver a third molding material to the third cavity that is different than the first and second molding materials delivered to the first and second cavities from the injection unit 3030.

We claim:

1. A method of forming a hollow article, comprising:
a) injecting a first molding material into a first mold cavity at a first injection pressure to form a first molded shell, the first molded shell having an outwardly bulging first body at least partially bounded by a first peripheral edge;
b) injecting a second molding material into a second mold cavity at a second injection pressure to form a second molded shell, the second molded shell having an outwardly bulging second body at least partially bounded by a second peripheral edge;
c) positioning the first shell and second shell into facing relation, with outer surfaces of the outwardly bulging first and second bodies directed away from one another and an empty chamber formed between them, and with the first and second peripheral edges proximate one another and disposed within a third mold cavity; and
d) injecting a third molding material into the third cavity at a third injection pressure to join together the first and second shells along the first and second peripheral edges to form the hollow article, the third injection pressure is less than the first injection pressure by at least about 3.5 bar, wherein inward deflection of the first and second shells as a result of injecting the third molding material is avoided.

2. The method of claim 1, wherein the second molding material is injected into the second cavity at a second injection pressure, the second injection pressure being one of (i) generally equal to the first injection pressure, and (ii) greater than the first injection pressure.

3. The method of claim 1, wherein the third molding material has a higher melt flow index than the first and second molding materials.

4. The method of claim 1, wherein the third molding material comprises a low molecular weight plastic resin.

5. The method of claim 1, wherein the third molding material comprises a gas that is mixed into the third molding material prior to injecting the third molding material into the third mold cavity.

6. The method of claim 5, wherein the gas, which may preferably comprise nitrogen, carbon dioxide, or ambient air, is introduced by a blowing agent comprising at least one of (i) a physical blowing agent (such as HCFC, hydrocarbons, liquid carbon dioxide); (ii) a chemical blowing agent (such as hydrazine, sodium bicarbonate); and (iii) the gas itself mechanically injected directly into the third molding material.

7. The method of claim 1, wherein the third injection pressure is less than about 175 bar.

8. The method of claim 1, wherein the first injection pressure is at least about 230 bar, and the third injection pressure is less than about 160 bar.

9. The method of claim 1, wherein the first injection pressure is in a range of about 240 bar to about 300 bar, and the third injection pressure is in a range of about 125 bar to about 150 bar.

10. The method of claim 1, wherein the third molding material is weld-compatible with the first and second molding materials.

11. The method of claim 1, wherein the first molding material comprises one of polypropylene and polyethylene, and the second molding material comprises a high heat-resistant material, the high heat-resistant material preferably having a continuous service temperature of at least 130 degrees Celsius, and in some examples, at least 150 degrees Celsius.

12. The method of claim 11, wherein the third molding material comprises a functionalized polyolefin.

13. The method of claim 12, wherein the third molding material comprises maleic anhydride grafted polyethylene.

14. The method of claim 1, wherein the first molding material comprises a first resin, the second molding material comprises a second resin, and the third molding material comprises a third resin.

15. The method of claim 14, wherein the first and second resins are polyolefin.

16. The method of claim 15, wherein the first and second resins are the same.

17. The method of claim 16, wherein the third resin is the same as the first and second resins.

18. The method of claim 14, wherein the first, second, and third resins are polyolefin.

19. The method of claim 14, wherein the first, second, and third resins are one of the group consisting of (i) polyethylene, and (ii) polypropylene.

20. The method of claim 11, wherein at least one of the first and second resins is polyamide.

21. The method of claim 1, wherein the first peripheral edge comprises a first flange having a first flange inner end proximate the first body and a first flange outer end spaced outwardly of the first flange inner end, and wherein the second peripheral edge comprises a second flange having a second flange inner end proximate the second body and a second flange outer end spaced outwardly of the second flange inner end, and wherein step (c) includes bringing the first flange inner end into abutment with the second flange inner end.

22. The method of claim 21, wherein step (c) includes closing opposing mold halves against the first and second flange inner ends, the third cavity extending outwardly from the first and second flange inner ends and about the first and second flange outer ends when the opposing mold halves are closed against the first and second flange inner ends.

23. The method of claim 1, wherein steps (a) and (b) are performed simultaneously.

24. The method of claim 23, wherein a first injection unit is used to perform steps (a) and (b).

25. The method of claim 23, wherein step (d) is performed at the same time that steps (a) and (b) are repeated in a subsequent cycle to produce another pair of first and second molded shells.

26. The method of claim 25, wherein step (d) is performed by the same first injection unit used to perform steps (a) and (b).

27. The method of claim 25, wherein a second injection unit is used to perform step (d).

28. A hollow article formed by the method of claim 1.

29. The hollow article of claim 28, wherein the hollow article comprises an automotive inlet duct.

30. A hollow article, comprising:
a) a first molded shell comprising a first molding material and formed by injecting the first molding material into a first cavity, the first molded shell having an outwardly bulging first body at least partially bounded by a first peripheral edge, the first peripheral edge comprising a first flange having a first flange inner end proximate the first body and a first flange outer end spaced outwardly of the first flange inner end;
b) a second molded shell comprising a second molding material and formed by injecting the second molding material into a second mold cavity, the second molded shell having an outwardly bulging second body at least partially bounded by a second peripheral edge, the second peripheral edge comprising a second flange having a second flange inner end proximate the second body and a second flange outer end spaced outwardly of the second flange inner end, the second molded shell oriented in facing relation to the first outer shell, with outer surfaces of the outwardly bulging first and second bodies directed away from one another and front surfaces of the first and second peripheral edges abutting one another; and
c) a bead comprising a third molding material and formed by injecting the third molding material into a third mold cavity, the bead extending along the first and second outer edges of the first and second peripheral edges, the bead joining together the first and second molded shells to form the hollow article.

31. The hollow article of claim 30, wherein the bead includes a first bead portion overlying and joined to a first back surface portion of the first flange opposite the first front face, and a second bead portion overlying and joined to a second back surface portion of the second flange opposite the second front face.

32. The hollow article of claim 31, wherein the first bead portion is spaced apart from the first body by a first gap, and the second bead portion is spaced apart from the second body by a second gap, the first and second gaps accommodating portions of respective first and second mold walls of the third mold cavity when forming the bead.
